(19) United States
(12) Patent Application Publication
(10) Pub. No.: US 2026/0083050 A1
(43) Pub. Date: Mar. 26, 2026

(54) ROBOTIC LAWN MOWER

(71) Applicant: Milwaukee Electric Tool Corporation, Brookfield, WI (US)

(72) Inventors: Dapeng Zhao, Franksville, WI (US); Caroline G. Fox, Richfield, WI (US); Robert A. Mones, Davidson, NC (US); Micah I. Reich, Atlanta, GA (US)

(21) Appl. No.: 19/110,362

(22) PCT Filed: Sep. 13, 2023
(86) PCT No.: PCT/US2023/074041

§ 371 Date: Mar. 10, 2025

Related U.S. Application Data
(60) Provisional application No. 63/406,580, filed on Sep. 14, 2022.

(51) Int. Cl. A01D 34/00; A01D 34/64; A01D 34/68; A01D 34/69; A01D 34/78; A01D 101/00; G05D 1/246; G05D 1/248; G05D 1/622; G05D 1/648; G05D 105/15; G05D 107/20

(52) U.S. Cl. CPC A01D 34/008; A01D 34/64; A01D 34/6806; A01D 34/69; A01D 34/78; G05D 1/246; G05D 1/248; G05D 1/622; G05D 1/648; A01D 2101/00; G05D 2105/15; G05D 2107/23

(57) ABSTRACT

A robotic lawn mower (100) includes a traction motor system (114) and a blade motor system (116) that, respectively, drives wheels (110) and drives a blade (108) of the robotic lawn mower (100). The robotic lawn mower also includes processing circuitry (102) for receiving user inputs that indicate a boundary (432), a mow pattern (1210), and/or a pre-planned path for a location (400). The processing circuitry (102) may control the traction motor system (114) and the blade motor system (116), in accordance with the user input, such that the robotic lawn mower (100) mows a lawn (430) at the location (400) based on the boundary (432), the mow pattern (1210), and/or the pre-planned path. The processing circuitry (102) may also detect an obstacle (820) in the lawn (430) based on the data generated by sensors (810) and operate the robotic lawn mower (100) to avoid the obstacle (820) and continue to mow the lawn based on the boundary (432), mow pattern (1210), and/or pre-planned path.

WO

### RELATED APPLICATIONS

The present application is based on and claims priority from U.S. patent application Ser. No. 63/406,580, filed on Sep. 14, 2022, the entire disclosure of which is incorporated herein by reference.

### BACKGROUND

Motorized lawn mowers are provided in several different forms, including walk-behind mowers and ride-on mowers. Walk-behind mowers may be manual pushed by an operator or, in some cases, may be self-propelled based on operator input at a handle of the mower. Ride-on mowers are self-propelled and include a seat or standing platform to carry an operator during mowing. More recently, autonomous mowers have been introduced.

### SUMMARY

Autonomous, or robotic, mowers generally operate without an operator physically touching the mower during operation. For example, the mowers may include sensors and control logic to automate various aspects of lawn mower operation. However, existing autonomous and robotic lawn mower systems and associated functionality are either too simple or too complex for various applications. For example, some existing robotic mowers, whether simple or complex, may require rigorous setup and planning for a particular lawn, and cannot quickly adapt to another lawn. Additionally, existing robotic mowers are inflexible and do not include various manual and autonomous modes. Described herein are robotic lawn mowers and associated systems and methods that overcome shortfalls of prior systems, providing improved efficiency in mowing (and, thus, help reduce labor costs, reduce wear on the mower), improved flexibility in operation, and improved service operations for mobile professionals (e.g., landscaping businesses, etc.), among other advantages.

Some embodiments of the disclosure provide a robotic lawn mower including a traction motor system, a blade motor system, sensors that generate data associated with operation of the robotic lawn mower, wheels driven by the traction motor system for moving and turning the robotic lawn mower, a blade driven by the blade motor system for cutting grass, and processing circuitry. The processing circuitry is configured to receive a user input from a user device, where the user input is received from a user via a user interface presented on the user device and the user input indicates a boundary and a mow pattern for the robotic lawn mower; operate the wheels and the blade of the robotic lawn mower, via control of the traction motor system and the blade motor system, in accordance with the user input such that the robotic lawn mower mows a lawn at the location based on the boundary and the mow pattern; detect an obstacle in the lawn based on the data generated by the sensors; and operate, via control of the traction motor system, the wheels of the robotic lawn mower such that the robotic lawn mower avoids the obstacle in the lawn and continues to mow the lawn based on the boundary and the mow pattern.

In some examples, the robotic lawn mower further includes a handle that moves between a first position and a second position, wherein the user guides the robotic lawn mower using the handle when the handle is in the first position, and wherein the robotic lawn mower operates without guidance from the user at the handle when the handle is in the second position. In some examples, the processing circuitry includes a microcontroller for receiving the data from the sensors and operating the wheels and the blade of the robotic lawn mower; and a computing device for receiving the data from the sensors from the microcontroller, generating commands used to operate the wheels and the blade of the robotic lawn mower based on the data from the sensors, and providing the commands to the microcontroller. In some examples, the processing circuitry is configured to save a map of the lawn at the location in a memory and use the map of the lawn at the location to mow the lawn at the location. In some examples, the processing circuity is further configured to determine the location of the robotic lawn mower by communicating with a beacon. In some examples, the beacon is installed in a vehicle or a trailer for transporting the robotic lawn mower, or the beacon is placed within the lawn by the user. In some examples, the processing circuitry is further configured to determine the location of the robotic lawn mower by communicating with one or more satellites.

Some embodiments of the disclosure provide a method. The method includes identifying, by a controller of a robotic lawn mower, a first location where the robotic lawn mower has been deployed; receiving, by the controller, information about a surrounding environment at the first location; controlling, by the controller, the robotic lawn mower to mow a lawn at the first location based on first a user input received from a user via a user interface, where the first user input indicates a first planned path for the robotic mower to follow to mow the lawn at the first location; and identifying, by the controller, a second location where the robotic lawn mower has been deployed.

In some examples, the method further includes receiving, by the controller, information a surrounding environment at the second location; and controlling, by the controller, the robotic lawn mower to mow a lawn at the second location based on a second user input received from the user via the user interface, the second user input indicating a second planned path for the robotic mower to follow to mow the lawn at the second location. In some examples, receiving the information about the surrounding environment at the first location includes receiving a boundary. In some examples, the method further includes detecting, by the controller, an obstacle in the lawn at the first location based on data generated by sensors on the robotic lawn mower; and operating, by the controller, wheels of the robotic lawn mower such that the robotic lawn mower avoids the obstacle. In some examples, the method further includes moving, by the controller, a handle of the robotic lawn mower between a first position and a second position based on whether the user provides guidance to the robotic lawn mower via the handle or does not provide guidance to the robotic lawn mower via the handle. In some examples, identifying the first location where the robotic lawn mower has been deployed includes communicating with a beacon that is installed in a vehicle or a trailer for transporting the robotic lawn mower or that is placed within the lawn by the user. In some examples, identifying the first location where the robotic lawn mower has been deployed comprises communicating with one or more satellites.

Some embodiments of the disclosure provide a robotic lawn mower including a traction motor system, a blade motor system, sensors configured to generate data associated with operation of the robotic lawn mower, wheels driven by the traction motor system for moving and turning the robotic lawn mower, a blade driven by the blade motor system for cutting grass, and processing circuitry. The processing circuitry is configured to identify a first location where the robotic lawn mower has been deployed; receive information about a surrounding environment at the first location; control the robotic lawn mower to mow a lawn at the first location based on first a user input received from a user via a user interface, the first user input indicating a first planned path for the robotic mower to follow to mow the lawn at the first location; and identify a second location where the robotic lawn mower has been deployed.

Some embodiments of the disclosure provide a method. The method includes receiving, by a controller of a robotic lawn mower, a user input from a user device, the user input received from a user via a user interface presented on the user device, the user input indicating a boundary and a mow pattern for the robotic lawn mower; operating, by the controller, wheels and a blade of the robotic lawn mower, via control of a traction motor system and a blade motor system, in accordance with the user input such that the robotic lawn mower mows a lawn at the location based on the boundary and the mow pattern; detecting, by the controller, an obstacle in the lawn based on the data generated by sensors coupled to the controller; and operating, by the controller, via control of the traction motor system, the wheels of the robotic lawn mower such that the robotic lawn mower avoids the obstacle in the lawn and continues to mow the lawn based on the boundary and the mow pattern.

### BRIEF DESCRIPTION OF THE DRAWINGS

The accompanying drawings, which are incorporated in and form a part of this specification, illustrate embodiments of the disclosure and, together with the description, explain principles of the embodiments.

FIG. 1 is an illustration showing an example robotic lawn mower.

FIG. 2 is a block diagram showing example components of the robotic lawn mower of FIG. 1.

FIGS. 3A-3B are illustrations showing functionality associated with a handle of the robotic lawn mower of FIG. 1.

FIG. 4 is an illustration showing a lawn at an example location where the robotic lawn mower of FIG. 1 can be used.

FIG. 5 is an illustration showing an example global positioning system involving satellite communications with the robotic lawn mower of FIG. 1.

FIG. 6 is an illustration showing an example real-time kinematic positioning system that can be used with the robotic lawn mower of FIG. 1.

FIG. 7 is an illustration showing another example real-time kinematic positioning system that can be used with the robotic lawn mower of FIG. 1.

FIG. 8 is an illustration showing an example ultrasound/radar sensor system that can be used with the robotic lawn mower of FIG. 1.

FIG. 9 is an illustration showing an example LIDAR scan that can be generated by the robotic lawn mower of FIG. 1.

FIG. 10 is an illustration showing an example camera image that can be generated by the robotic lawn mower of FIG. 1.

FIGS. 11A-11C are illustrations showing components of an example beacon system that can be used with the robotic lawn mower of FIG. 1.

FIG. 12 is an illustration showing different example mow patterns that can be implemented using the robotic lawn mower of FIG. 1.

FIG. 13 is a flow diagram showing a mobile mowing process that can be implemented using the robotic lawn mower of FIG. 1.

### DETAILED DESCRIPTION

A robotic lawn mower can serve as an assistant for a mobile professional and travel with the mobile professional between different locations. The robotic lawn mower includes various sensors for identifying the location of the robotic lawn more and for detecting obstacles in the path of the robotic lawn mower. A user of the robotic lawn mower can provide a user input via a user interface presented on a user device to affect operation of the robotic lawn mower. The user input can include a boundary, a mow pattern, and/or a planned path for the robotic lawn mower to follow, for example. The robotic lawn mower can operate either with direct (manual) guidance from the user or without direct guidance from the user, thereby allowing the user to perform various tasks (e.g., other landscaping and lawn care services) while the robotic lawn mower continues to mow the lawn at the location autonomously. The robotic lawn mower can include a handle that moves between positions based on whether the user provided direct guidance to the robotic lawn mower. The robotic lawn mower can provide more dynamic functionality than simple approaches such as induction loop boundary wires, and can be more inexpensive and compact than more complex stationary approaches.

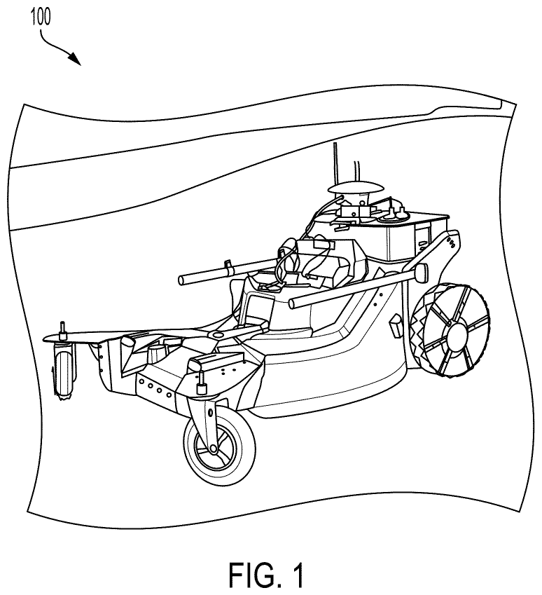

FIG. 1 is an illustration showing an example robotic lawn mower 100. Robotic lawn mower 100 generally operates to cut grass and mow lawns without being directly operated by a human, at least for some portion of time during the mowing process. By using robotic lawn mower 100, mobile professionals such as landscaping business, lawn care businesses, and other similar types of businesses and combinations thereof can reduce crew size and improve service operations. For example, instead of requiring two employees to travel to and work at a location (e.g., a residential home, a commercial building), only one employee may travel to and work at the location to complete lawn care and other services. Accordingly, robotic lawn mower 100 can be used to reduce labor requirements (e.g., fewer employees needed) and reduce labor costs while also providing more effective and customizable lawn care services for various customers. In some implementations, the deck size of robotic lawn mower is between 30 and 33 inches so that it can fit through a standard gate. The illustration of robotic lawn mower provided in FIG. 1 is an example prototype, and variations to the design shown in FIG. 1 are contemplated within the scope of the present disclosure.

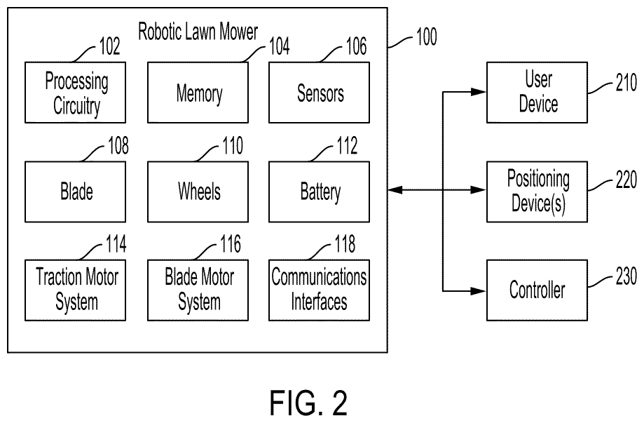

FIG. 2 illustrates a block diagram of example components of robotic lawn mower 100. The block diagram in FIG. 2 also shows different systems and devices that can be in communication with robotic lawn mower 100. As shown in FIG. 2, robotic lawn mower 100 includes a variety of components including processing circuitry 102, memory 104, sensors 106, a blade 108, wheels 110, a battery 112, a traction motor system 114, a blade motor system 116, and communications interfaces 118. Also, as shown in FIG. 2, robotic lawn mower 100 is in communication with a user device 210, one or more positioning devices 220, and a controller 230.

Processing circuitry 102 (also referred to as a controller of robotic lawn mower 100) can generally include any suitable type of data processing hardware components and combinations thereof. For example, processing circuitry 102 can be implemented using a variety of different types and/or combinations of processing components and circuitry, including various types of microprocessors, central processing units (CPUs), graphics processing units (GPUs), and other computing devices. In some implementations, processing circuitry 102 includes both a Teensy 4.0 microcontroller and miniature desktop personal computer (mini-PC), which can provide advantages specifically for mobile professional applications due to the combination of processing resources provided and cost. Processing circuitry 102 can generally process a variety of different types of data, including user inputs provided via user device 210, positioning and location data provided by positioning devices 220, data provided by controller 230, and data provided by sensors 106, traction motor system 114, and blade motor system 116. Processing circuitry can use this data to identify locations where robotic mower 100 has been deployed, affect operation of robotic mower 100 (e.g., to mow in accordance with a boundary, a mow pattern, a planned path, avoid obstacles, etc.), and generally operate robotic lawn mower 100. One or more components of processing circuitry 102, such as a mini-PC, can use the open-source Robot Operating System (ROS) to manage and interpret data. Processing circuity 102 can use signal processing techniques such as extended Kalman filters (EKFs), moving horizon estimation (MHE), and other similar components for signal processing. Processing circuity 102 can also execute different types of obstacle detection and mapping algorithms, as well as path-planning and decision-making algorithms. Processing circuitry 102 can also execute a localization algorithm that can be a standalone software module.

Memory 104 can generally be implemented using any suitable type or types of memory, including read-only memory (ROM), random access memory (RAM), volatile memory, non-volatile, other non-transitory computer-readable media, and/or various combinations thereof. Data stored in memory 104, including instructions for performing various operations using robotic lawn mower 100, can be generated by wireless devices (e.g., a smartphone, a laptop, a tablet, etc., such as user device 210), one or more servers, sensors 106, traction motor system 114, blade motor system 116, and other systems and devices. Some of the data stored in memory 104 can be loaded onto robotic lawn mower 100 at the time of manufacturing, and other data can be stored in memory 104 during the operational lifetime of robotic lawn mower 100. Memory 104 can store historical data associated with different locations, including information about the surrounding environment at the location (e.g., location of obstacles, elevations, type of grass and other landscaping, etc.), previous paths (routes) taken to complete lawn mowing at the location, preferences associated with the location (e.g., mow patterns, mow height, etc.), and other historical data. At least some of this historical data can be stored on one or more servers and downloaded to memory 104 by robotic lawn mower 100 as needed.

Sensors 106 can include a variety of different types and combinations of sensors used in the operation of robotic lawn mower 100. It will be appreciated that certain combinations of sensors used to implemented 106, as contemplated in the disclosure, can provide advantages for the mobile professional in terms of cost and functionality. The selection of sensor 106 used to implement robotic lawn mower 100 can provide a robotic lawn mower with the ability to move between locations and operate as an assistant to the mobile professional. Sensors 106 can include, for example, global positing system real-time kinematics (GPS-RTK) sensor modules and components (e.g., including a receiver for receiving signals from the global navigation satellite system (GNSS) and real time kinetics information to account for errors or disturbances in the satellite-generated signals), an inertial measurement unit (IMU) such as a three degrees of freedom (DOF) magnetometer or a 9-DOF IMU for generating data indicative of specific force, angular rate, and orientation, rotary encoders, cameras (e.g., red-green-blue (RGB) cameras, depth cameras, wide-angle cameras, etc.), light detection and ranging (LIDAR) sensors (e.g., one-dimensional (1D), two-dimensional (2D), three-dimensional (3D), 360-Degree, etc.) utilizing a laser, ultrasound and radar sensors, temperature sensors, presence sensors, pressure sensors, humidity sensors, and other types of sensing components, devices, and systems. Sensors 106 generate and provide data used by robotic mower 100 to navigate about its environment, for example to avoid obstacles, detect boundaries, and follow a planned path.

Blade 108 can generally be implemented using a variety of suitable types of blades for cutting grass and performing other types of landscaping functions. For example, blade 108 can be implemented using straight blades, low-lift blades, high-lift blades, mulching blades, gator blades, and other types and combinations of blades depending on the intended application. Blade 108 can generally be driven by blade motor system 116 to rotate with a force such that blade 108 can cut grass, mow lawns, and perform other types of landscaping functions. In some implementations, sensors 106 can generate data indicative of the operation of blade 108 that can be used by processing circuitry 102 to ensure proper functioning of blade 108. Also, the height of blade 108 can be adjusted automatically or based on user input to control, for example, the degree to which grass in a lawn is cut.

Wheels 110 can generally be implemented using a variety of different types and combinations of wheels. For example, in some implementations, robotic lawn mower 100 includes a pair of matching rear wheels and a pair of matching front wheels, where the rear wheels are larger than the front wheels. The front wheels can be implemented using wheel casters (e.g., a wheel assembly including a wheel and a mounting bracket coupled to the wheel), and the rear wheels can be independently driven. Wheels 110 can generally be turned and rotated to facilitate movement of robotic lawn mower 100. Wheels 110 can be driven by traction motor system 114 to control movement of robotic mower 100, for example to avoid obstacles, detect boundaries, and follow a planned path. Sensors 106 can generate data indicative of operation of wheels 110 so that robotic lawn mower 100 can maintain intended operational parameters. Each of wheels 110, or each driven wheel 110, can have or be associated with a dedicated encoder used to generate signals indicative of the wheel positions. For example, each motor of traction motor system 114 may include a rotary encoder or one or more Hall sensors to indicate a rotor position of the motor, which may be indicative of the position of wheel 110 corresponding to the motor.

Battery 112 can be implemented using a variety of suitable types of batteries and combinations thereof. For example, battery 112 can be a lithium-ion battery, a lithium iron phosphate (LFP) battery, and other similar types of batteries that can serve as a power supply for robotic lawn mower 100 and various components thereof. In some examples, battery 112 is a power tool battery pack, or two or more power tool battery packs, that may be selectively inserted into and removed from a corresponding battery port (or ports) on robotic lawn mower 100. When removed from mower 100, the power tool battery packs may be received by and power other power tools (e.g., impact drivers, circular saws, drill-drivers, worksite lighting, etc.). Each battery port of robotic lawn mower 100 may be configured to electrically and mechanical couple to a battery pack serving as battery 112. Since robotic lawn mower 100 is powered by a battery, it can provide advantages in terms of noise reduction and environmental benefits when compared to gas-powered internal combustion engines that can be used in other lawn mowers. Battery 112 can also allow for a lighter lawn mowing device, which can reduce chances of potential damage to lawns. Robotic lawn mower 100 can include charging circuitry and a power cable for coupling to an external power source (e.g., a standard alternating current (AC) wall outlet) and may charge battery 112 between uses.

Traction motor system 114 can be implemented using a variety of suitable components, and can provide different functionality depending on the application. For example, traction motor system 114 can include an inverter, one or more encoders, drives (e.g., brushless motor driver), stators, rotors, axles, and other suitable components and combinations thereof. Traction motor system 114 can generate power to drive wheels 110 by rotating and turning wheels 110 and thereby control movement of robotic lawn mower 100. Traction motor system 114 can receive control signals from processing circuitry 102 and use the control signals to control motor operation. In some implementations, traction motor system 114 can send encoder velocity readings to processing circuitry 102 and receive configuration and motor control commands from processing circuitry 102 via a universal a synchronous receiver-transmitter (UART) interface.

In some examples, traction motor system 114 includes a left traction motor and a right traction motor, where the left traction motor is configured to drive left rear wheel 110 of mower 100 and the right traction motor is configured to drive right rear wheel 110. The left and right traction motors may be independent controlled by the processing circuitry 102. For example, processing circuitry 102 may generate respective pulse-width modulated (PWM) drive signals for a respective inverter for each of the left and right traction motors. Generally, to drive straight, processing circuitry 102 may provide PWM drive signals of an equal duty cycle to both a left inverter for the left traction motor and a right inverter for the right traction motor; to turn the mower left, processing circuitry 102 may provide a PWM drive signal of a lower duty cycle to the left inverter for the left traction motor and of a higher duty cycle to the right inverter for the right traction motor (to cause right rear wheel 110 to rotate faster than left rear wheel 110); and to turn the mower right, processing circuitry 102 may provide a PWM drive signal of a higher duty cycle to the left inverter for the left traction motor and of a lower duty cycle to the right inverter for the right traction motor (to cause right rear wheel 110 to rotate slower than left rear wheel 110). In other examples, rear wheels 110 may be driven in unison (e.g., by a single rear traction motor), and additional steering motors may be provided that are controlled by processing circuitry 102 to turn front wheels 110 to turn mower 100 in a desired direction.

Blade motor system 116 can also be implemented using a variety of suitable components, and can provide different functionality depending on the application. For example, blade motor system 116 can also include an inverter, one or more encoders, drives (e.g., brushless motor driver), a shaft, a stator, a rotor, and other suitable components and combinations thereof. Blade motor system 116 can generate power to drive blade 108 by rotating blade 108 with a given torque and thereby control movement of blade 108 to perform actions such as cutting grass. Blade motor system 116 can receive control signals from processing circuitry 102 and use the control signals to control motor operation. In some implementations, blade motor system 116 can send encoder velocity readings to processing circuitry 102 and receive configuration and motor control commands from processing circuitry 102 via a universal a UART interface. In some examples, the traction motor system 114 and blade motor system 116 may share a motor as a driving source, where a gearing system is provided to obtain the desired rotation speeds of blade 108 and wheels 110, and a clutch system is provided to selectively engage and disengage the driving of blade 108 and wheels 110.

Communications interfaces 118 can include a variety of different hardware and software used for electronic communications in accordance with various communications protocols. For example, communications interfaces 118 can include various serial communications interfaces (e.g., busses) including UART communications interfaces, I²C (inter-integrated circuit) communications interfaces, serial peripheral interfaces (SPI), universal serial bus (USB) communications interfaces, and the like. Communications interfaces 118 can also perform communications using pulse width modulation (PWM) techniques. Communications interfaces 118 can include wireless modules, including radio transceivers and antennas, for wireless communications using protocols such as Bluetooth and Wi-Fi. Communications interfaces 118 can also include circuitry for receiving and processing signals broadcast by devices such as beacons, satellites, and base stations, among other suitable types of components used for different types of electronic communications.

User device 210 can be implemented as any type of electronic device that can present a user interface to a user and receive a user input from the user via the user interface. In some implementations, user device 210 is a smartphone carried by a mobile professional using robotic lawn mower 100 to automate at least part of lawn care and other landscaping services performed by the mobile professional. User device 210 can, for example, be a smartphone, a tablet, a personal computer, a workstation, a laptop, a gaming device, a wearable device (e.g., a smart watch, etc.), and other suitable types of devices. User device 210 can run a web browser or a mobile application, for example, to allow the user to view and manipulate a variety of data associated with robotic lawn mower 100 via a user interface. The user can view and confirm location data associated with robotic lawn mower 100, view estimated time remaining to complete lawn mowing, view alerts generated by robotic lawn mower 100, identify and draw boundaries at a given location, choose between different types of mow patterns, and generate planned paths for robotic lawn mower 100 via the user interface. The user interface can also allow the user to save accounts and make notes. This functionality allows for robotic lawn mower 100 to serve as an assistant to the mobile professional, where robotic lawn mower 100 is not too expensive, but can still dynamically perform high quality lawn care and landscaping services and operate with assistance from the user or without assistance form the user.

Positioning devices 220 can include various types and combinations of devices and systems used in determining the position of robotic lawn mower 100. For example, positioning devices 220 can include one or more beacons installed in various locations (e.g., such as discussed in more detail below) that can serve as reference points for robotic lawn mower 100 when navigating through a lawn at a location. Positioning devices 220 can also include devices such as satellites and other types of devices used for location sensing and identification, such as a local base station used in a real-time kinematics system. Robotic lawn mower 100 can communicate with positioning devices using communications interfaces 118. For example, robotic lawn mower can communicate with a base station of positioning devices 220 (e.g., to receive real time kinematics information) using an antenna in communication with a GPS-RTK receiver and a long range (LoRa) radio (e.g., 915 MHz). Position devices 220 can use the Radio Technical Commission for Maritime Services (RTCM) to receive and apply RTCM correction data and determine a more accurate position of robotic lawn mower 100.

Controller 230 can be implemented using a variety of different hardware and software components, and generally serves as an external device used in the control of robotic lawn mower 100. Controller 230 can be implemented using one or more servers, a wireless controller device, and other types of electronic devices depending on the application. In some implementations, controller 230 can be a wireless controller including a microcontroller (e.g., Teensy 4.0 microcontroller, etc.) that receives inputs from a user (e.g., mobile professional) via a game controller device (e.g., including push buttons and one or more joysticks) connected to the microcontroller via USB and sends data (e.g., commands) to robotic lawn mower 100 via a LoRa radio. The ability to provide inputs used to control robotic lawn mower 100 via a game controller in this manner can provide the user with a simple and efficient mechanism for steering robotic lawn mower 100 during navigation. Controller 230 can read joystick and button inputs from the game controller and repackage and transmit these inputs over radio when requested by robotic lawn mower 100. Processing circuitry 102 may receive and translate these inputs into control signals to drive traction motor system 114 and/or blade motor system 116. The particular number, types, and locations of components with robotic lawn mower 100 of FIG. 2 are merely used as an example for discussion purposes, and thus additional or different types of components can be present in other implementations.

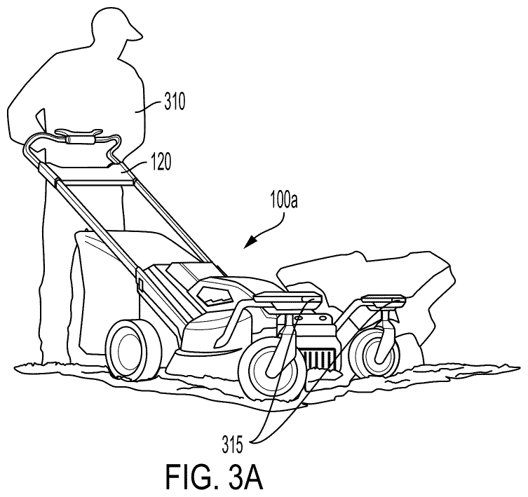

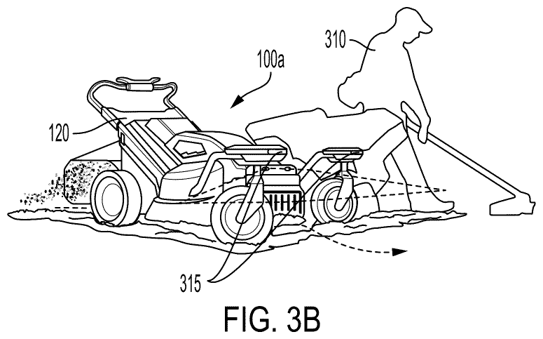

FIGS. 3A-3B are illustrations showing functionality associated with a handle 120 of robotic lawn mower 100a, which is another example of the mower 100 with similar components and functionality as mower 100 described herein, except for any differences noted herein. Further, below references to the robotic lawn mower 100 (e.g., the functionality of lawn mower 100, including with respect to the process of FIG. 15) similarly apply to mower 100a. In other words, unless specifically noted otherwise, references and description of robotic lawn mower 100 made herein may be considered as a general reference to, and description applicable to, both mower 100 and mower 100a. As shown specifically in FIG. 3A, when a user 310 is operating robotic lawn mower 100a via handle 120, handle 120 is in a first, extended position such that user 310 can guide robotic lawn mower 100a during operation using handle 120. In other words, mower 100a is illustrated in a direct (manual) guide mode (a first operation mode) in FIG. 3A. As shown specifically in FIG. 3B, when user 310 is not operating robotic lawn mower 100a using handle 310 but mower 100a is instead operating autonomously, handle 120 is in a second, collapsed position such that handle 120 is less likely to collide with any surrounding obstacles. In other words, mower 100a is illustrated in an autonomous mode (a second operation mode) in FIG. 3B. As illustrated, while mower 100a is operating autonomously, the user is able to perform other tasks (e.g., weed whacking, trimming bushes, etc.) simultaneously with mower 100a mowing. This functionality associated with handle 120 provides an effective mechanism for the mobile professional to both guide robotic lawn mower 100 when desired but also allow robotic lawn mower 100 to operate on its own when desired. In some examples, handle 120 may include telescoping legs, each leg including interconnected slidable sections (e.g., of a hollow pipe or conduit) of different diameters to enable collapsing and extension of the leg. Handle 120 can be collapsed (e.g., moved between the first position in FIG. 3A and the second position in FIG. 3B) automatically by robotic lawn mower 100 (e.g., by control of processing circuitry 102 based upon detecting user 310 is no longer present using sensors 106, based on a user input, etc.) or manually by user 310. With respect to automatic control, for example, processing circuitry 102 may control a motor or hydraulic system coupled to handle 120 to drive the extension or collapse of handle 120.

As shown in FIGS. 3A-3B, in some examples, mower 100a further includes front lights 315 to illuminate a working area in front of mower 100a, one positioned above a front left wheel and one positioned above a front right wheel. In some examples, mower 100 of FIG. 1 includes front lights 315 of mower 100a, collapsible handle 120 of mower 100a, or both.

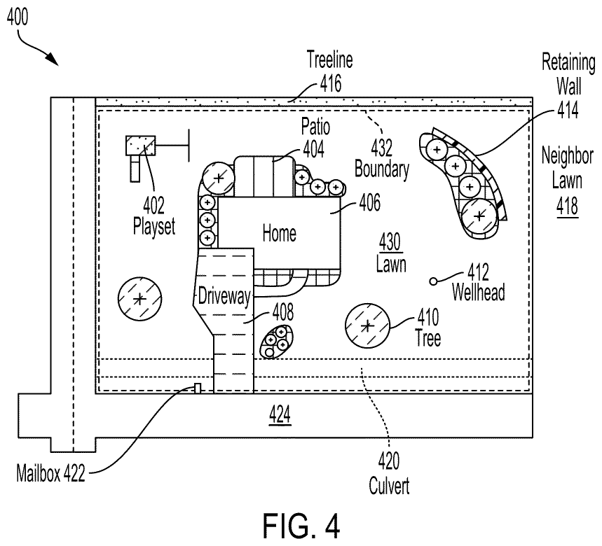

FIG. 4 is an illustration showing a lawn at an example location 400 where robotic lawn mower 100 can be used. Location 400 is a residential location including a residential lawn 430 as defined by a boundary 432. At location 400, boundary 432 of lawn 430 is defined by a road 424, a tree line 416, and a neighbor lawn 418. Lawn 430 includes a variety of different obstacles as illustrated in FIG. 4, including a playset 402, a patio 404, a home 406, a driveway 408, a tree 410, a wellhead 412, a retaining wall 414, a culvert 420, and a mailbox 422. It will be appreciated that different types of obstacles can exist at different locations where robotic lawn mower 100 can be used, including both residential and commercial locations. It will further be appreciated that different locations may have lawns of different sizes and shapes, may be bordered by different items, and defined by different boundaries. Via sensors 106, robotic lawn mower 100 when mowing lawn 430 can detect and avoid playset 402, patio 404, home 406, driveway 408 tree 410, wellhead 412, retaining wall 414, culvert 420, and mailbox 422, and robotic lawn mower 100 can also detect and stay within boundary 432 such that it avoids road 424, tree line 416, and neighbor lawn 418. Via input provided via a user interface on user device 210, users can control operation of robotic lawn mower at location 400 by, for example, defining boundary 432, selecting a mow pattern, and/or planning a path for robotic lawn mower 100 to follow.

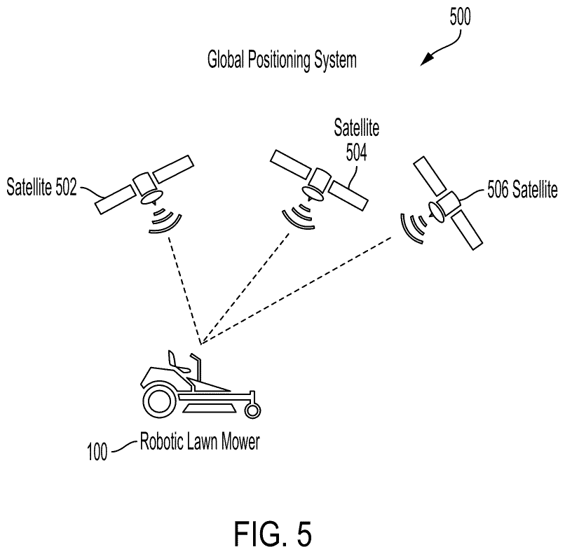

FIG. 5 is an illustration showing example global positioning system 500 involving satellite communications with robotic lawn mower 100. As shown, robotic lawn mower 100 communicates with a satellite 502, a satellite 504, and a satellite 506. Robotic lawn mower 100 can communicate with satellite 502, satellite 504, and satellite 506. For example, mower 100 may include a GNSS receiver as a location sensor of sensors 106. In some implementations, satellite 502, satellite 504, and satellite 506 are GPS satellites that circle the planet Earth twice per day in a precise orbit and transmit unique signals and orbital parameters. Robotic mower 100, via the GNSS receiver, can receive and decode these signals and orbital parameters from satellite 502, satellite 504, and satellite 506 to compute the precise location of satellite 502, satellite 504, and satellite 506 and also use trilateration to calculate its own location. Based on the received signals, the GNSS receiver may output location data to processing circuitry 102 indicative of the location of mower 100. Accordingly, processing circuitry 102 may determine the location of mower 100 based on the location data from the GNSS receiver. Other types of satellite communication for determining location and communication various parameters associated with operation of robotic lawn mower 100 are used in other examples.

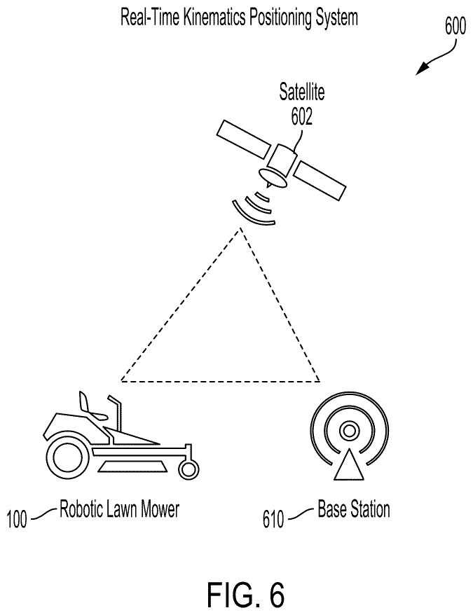

FIG. 6 is an illustration showing an example real-time kinematic positioning system 600 that can be used with robotic lawn mower 100. As shown in FIG. 6, robotic lawn mower 100 is in communication with both a satellite 602 and a base station 610. Satellite 602 may be a single satellite or, in other examples, represents multiple satellites (e.g., similar to satellites 502, 504, and 506). Mower 100 may include a GPS-RTK receiver as a location sensor of sensors 106. When operating at location 400, for example, base station 610 can be placed somewhere at or near location 400 (e.g., within a few or several meters of location 400). For example, base station 610 may travel with a user of mower 100 from location to location and, accordingly, may be positioned by the user at or near location 400 shortly before beginning a mowing operation. In some examples, base station 610 is statically positioned within a few miles of mower 100 and is associated with and maintained by a third party or public entity (potentially as part of a network of base stations). Real-time kinematics system 600 generally uses surveying to correct for common errors in satellite navigation systems, such as GPS systems using the GNSS. Real-time kinematics system 600 uses measurements of the phase of the satellite signal's carrier wave and relies on base station 610 to provide real-time position data correction, and thereby more precise and accurate (e.g., centimeter-level) location and position data. Base station 610 can communicate with robotic lawn mower 100 (e.g., the GPS-RTK receiver) via different radio frequencies (e.g., 2,4 GHz, Bluetooth, etc.). In some examples, the GPS-RTK receiver may include a GNSS receiver, as described with respect to FIG. 5, as well as an RTK receiver for receiving the correction data from base station 610. Based on the received signals from satellite(s) 602 and the correction data from base station 610, the GPS-RTK receiver may output location data to processing circuitry 102 indicative of the location of mower 100. Accordingly, processing circuitry 102 may determine the location of mower 100 based on the location data from the GNSS receiver. Accordingly, using example real-time kinematic positioning system 600, as opposed to satellite communications without similar correction data, can provide better location tracking for robotic lawn mower 100.

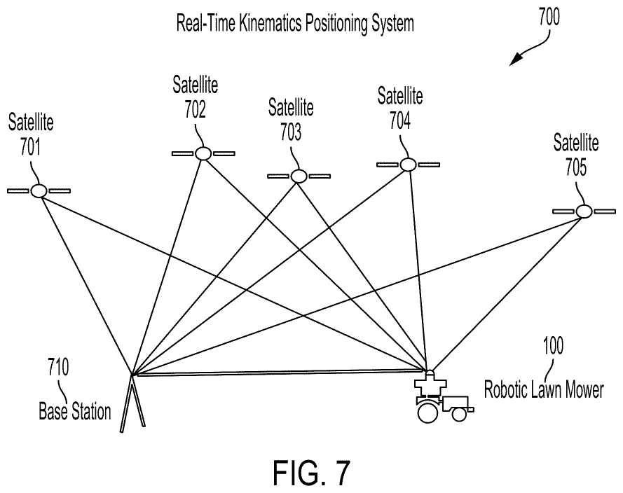

FIG. 7 is an illustration showing another example real-time kinematic positioning system 700 that can be used with robotic lawn mower 100. In real-time kinematic positioning system 700, both robotic lawn mower 100 and a base station 710 (analogous to base station 610) communicate with multiple different satellites, including a satellite 701, a satellite 702, a satellite 703, a satellite 704, and a satellite 705. Mower 100 may again include an GPS-RTK receiver. A variety of different real-time kinematics system configurations are contemplated for use with robotic lawn mower 100. Base station 610 and base station 710 can interface with a GPS-RTK base station module to get RTCM correction data for the particular area in which base station 610 or 710 are located (e.g., over a network connection, such as to the Internet or another network), and then buffer and transmit the correction data over radio when requested by robotic lawn mower 100, for example. In some implementations, base station 610 and base station 710 are not included in a system with mower 100. For example, in place of base station 610 and base station 710, mower 100 may include a mobile Internet connection for global RTCM data streaming (e.g., from a third-party source or server that maintains and provides such data). Regardless of the particular configuration, the GPS-RTK receiver may include a GNSS receiver, as described with respect to FIG. 5, as well as an RTK receiver for receiving the correction data from base station 610, base station 710, or via a connection to a source for global RTCM data stream. Based on the received signals from the satellite(s) and the correction data, the GPS-RTK receiver may output location data to processing circuitry 102 indicative of the location of mower 100. Accordingly, processing circuitry 102 may determine the location of mower 100 based on the location data from the GNSS receiver.

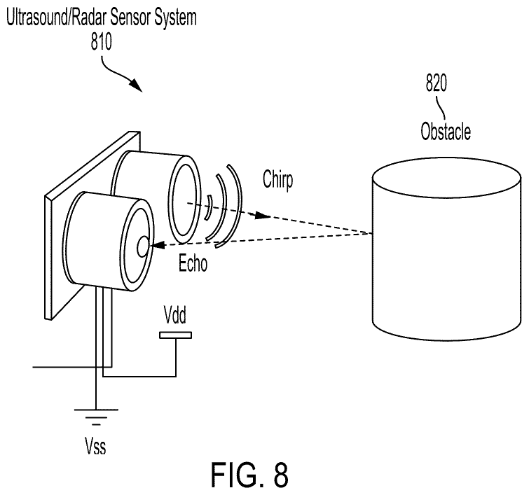

FIG. 8 is an illustration showing an example ultrasound/radar sensor system 810 that can be used with robotic lawn mower 100 (e.g., as a sensor of sensors 106). System 810 can include antennas for transmitting signals and receiving signals reflected from an obstacle 820, as shown in FIG. 8. System 810 can be used to detect the presence of obstacle 820 such that robotic lawn mower 100 can avoid obstacle 820 when navigating through an environment. In some examples, sensor system 810 implements ultrasound detection by emitting ultrasound signals via an emitter, receiving reflected ultrasound signals via a receiver, and processing the received ultrasound signals to detect obstacles and their location relative to mower 100. In some examples, sensor system 810 implements radar detection by emitting radio signals via an emitter, receiving reflected radio signals via a receiver, and processing the received radio signals to detect obstacles and their location relative to mower 100. In both the ultrasound and radar examples, sensor system 810 may provide to processing circuitry 102 obstacle data indicative the presence of and/or location of obstacles (e.g., including distance to the obstacle and/or direction of the obstacle). In some examples, ultrasound/radar sensor system 810 includes both ultrasound and radar detection. System 810 can use echo signals that are reflected to an antenna from obstacle 820 as well as chirp signals that are reflected to an antenna from obstacle 820 and are compressed by system 810. As shown in FIG. 8, system 810 can be powered via connection to a supply voltage and a reference ground voltage. System 810 provides an example implementation of a sensor included in sensors 106 on robotic lawn mower 100. The obstacle data generated by system 810 can be used by processing circuitry 102 to affect operation of robotic lawn mower 100.

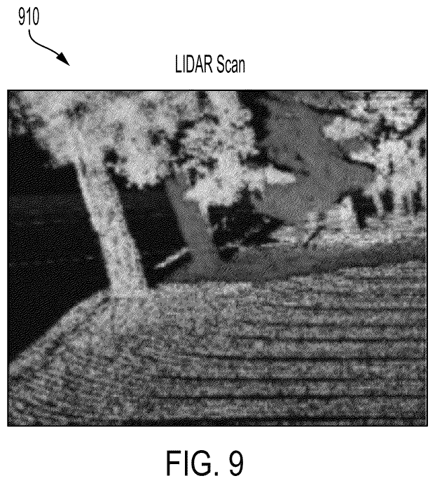

FIG. 9 is an illustration showing an example LIDAR scan 910 that can be generated by robotic lawn mower 100. The example LIDAR scan 910 can be generated by a 3D LIDAR sensor included in sensors 106 on robotic lawn mower 100. LIDAR scan 910 can provide an indication of distance between surrounding objects and robotic lawn mower 100, and can be provided to the processing circuitry 102 by the 3D LIDAR sensor and used by processing circuitry 102 to affect operation of robotic lawn mower 100 accordingly. For example, when operating at location 400, if processing circuitry 102 determines that robotic lawn mower is about to collide with wellhead 412 based on a LIDAR scan, processing circuitry 102 can provide a control signal to traction motor system 114 such that robotic lawn mower 100 avoids wellhead 412. Different colors and/or other visual indications can be included with LIDAR scan 910 to indicate proximity of surrounding objects. In some implementations, LIDAR scan 910 can be viewed by a user via a user interface presented on user device 210. One or more LIDAR sensors that can produce scans such as LIDAR scan 910 can be mounted on robotic lawn mower 100 in different configurations to provide robotic lawn mower 100 with appropriate sensing capabilities for different applications.

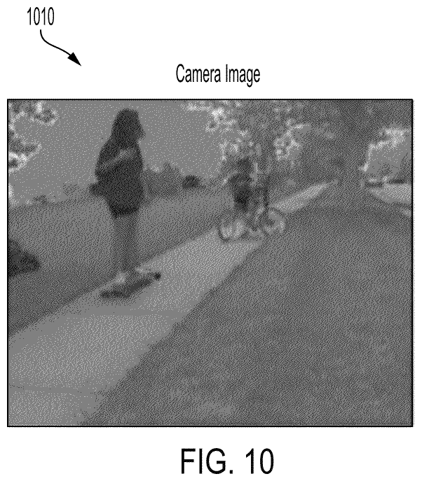

FIG. 10 is an illustration showing an example camera image 1010 that can be generated by robotic lawn mower 100. The example camera image 1010 can be generated by a RGB camera included in sensors 106 on robotic lawn mower 100 and received by processing circuitry 102. Camera image 1010 can provide a pixelated data indicative of the environment surrounding robotic lawn mower 100, and can be used by processing circuitry 102 to affect operation of robotic lawn mower 100 accordingly. For example, processing circuitry 102 may include image processing software that analyzes images generated by the camera of the sensors 106 to detect obstacles, boundaries, and the like. For example, when operating at location 400, if processing circuitry 102 determines that robotic lawn mower is about to collide with tree 410 based on analysis of a camera image, processing circuitry 102 can provide a control signal to traction motor system 114 such that robotic lawn mower 100 avoids tree 410. In some implementations, camera image 1010 can be viewed by a user via a user interface presented on user device 210. One or more cameras that can produce images such as camera image 1010 can be mounted on robotic lawn mower 100 in different configurations to provide robotic lawn mower 100 with appropriate sensing capabilities for different applications.

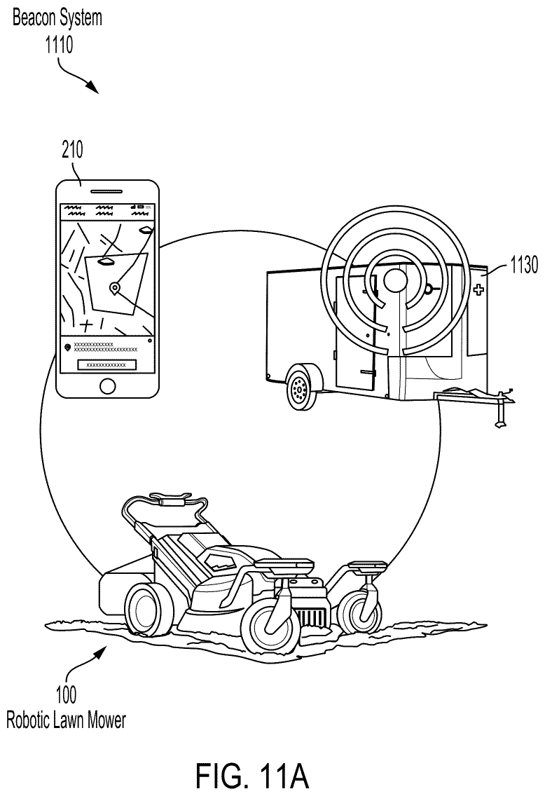

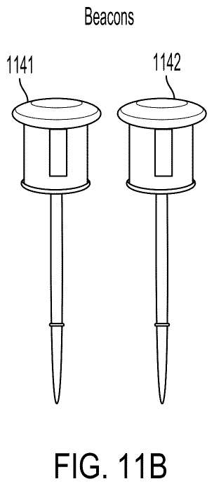

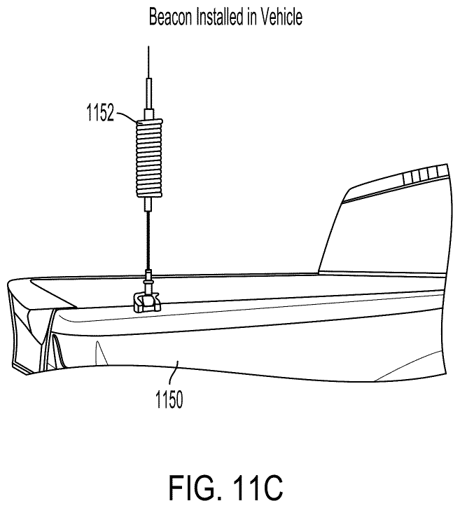

FIGS. 11A-11C are illustrations showing components of an example beacon system 1110 that can be used with robotic lawn mower 100. FIG. 11A specifically shows main components of beacon system 1110, including robotic lawn mower 100, user device 210, and a trailer 1130. Trailer 1130 can include a base station (e.g., like base station 610 or base station 710) used as part of a real-time kinematics positioning system (e.g., like real-time kinematics positioning system 600 and real-time kinematics positioning system 700). Trailer 1130 can also more generally include one or more beacon devices, such as beacon 1141 and beacon 1142 shown in FIG. 11B. Beacon 1141 and beacon 1142 may not communicate with satellites like a base station in a real-time kinematics system, but can instead be implemented as Bluetooth low energy (BLE) beacons or ultrawideband (UWB) beacons used as anchors or reference points for robotic lawn mower 100. Based on signals broadcast by beacon 1141 and/or beacon 1142, robotic lawn mower 100 can determine its location relative to beacon 1141 and/or beacon 1142. Beacon 1141 and/or beacon 1142 can be placed within a lawn such as lawn 430 or within a trailer such as trailer 1130 used to transport robotic lawn mower 100 between locations, for example. As shown in FIG. 11C, a beacon 1152 analogous to beacon 1141 and beacon 1142 can likewise be placed in a vehicle 1150 (e.g., a pickup truck, etc.) used to transport robotic lawn mower 100 between locations. Various types and configurations of beacon system 1110 are contemplated and can be used with robotic lawn mower 100 for determining location. Data associated with beacon system 1110 can also be managed and configured by a user via a user interface presented on user device 210.

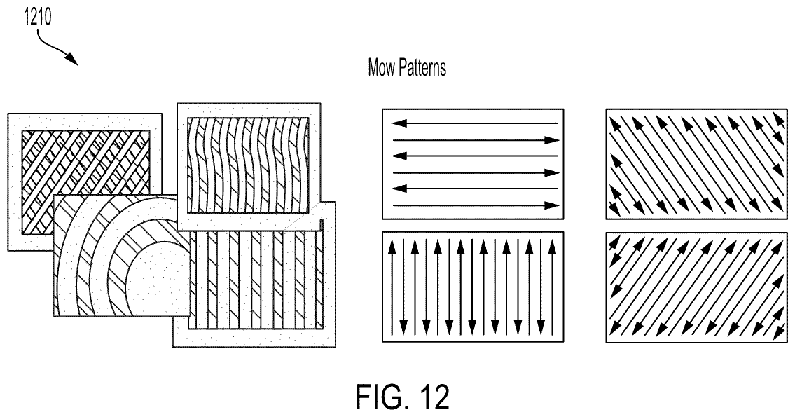

FIG. 12 is an illustration showing different example mow patterns 1210 that can be implemented using robotic lawn mower 100. Mow patterns 1210 are shown to include vertical patterns, horizontal patterns, circular patterns, diagonal patterns, checkered patterns, and curved patterns, for example. Various mow patterns, including the example mow patterns 1210 shown in FIG. 12, can be implemented by robotic lawn mower 100 based on input received from a user via a user interface presented on user device 210. The ability to customize mow patterns in this manner can provide advantages in terms of user experience and satisfaction with lawn care services performed by a mobile professional using robotic lawn mower 100.

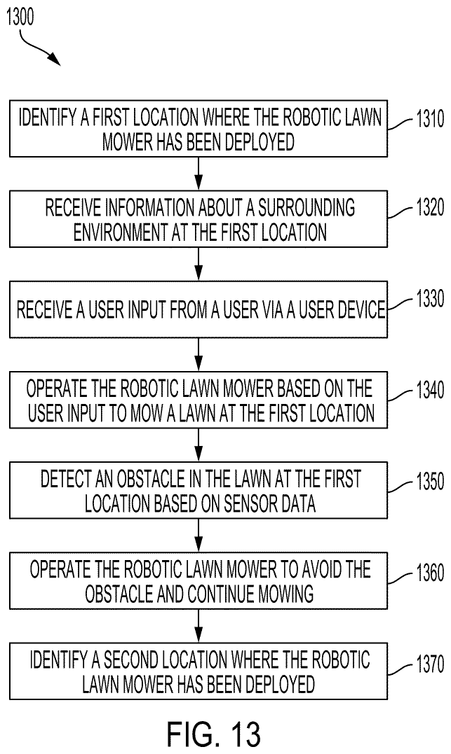

FIG. 13 is a flow diagram showing a mobile mowing process 1300 that can be implemented using robotic lawn mower 100. Process 1300 can provide advantages for the mobile professional in terms of providing exceptional lawn care services at a reasonable price while also reducing labor cost and requirements. Process 1300 generally involves receiving a user input from a user via user device 210, and operating robotic lawn mower 100 in accordance with the user input. Robotic lawn mower 100 can thereby serve as an assistant to the user, such that the user can either directly operate robotic lawn mower 100 if desired or the user can allow robotic lawn mower 100 to operate on its own with guidance provided by the user via the user interface. Accordingly, the user can attend to other tasks such as trimming bushes and other landscaping tasks while robotic lawn mower 100 continues to cut grass on its own.

At block 1310, robotic lawn mower 100 identifies a first location where robotic lawn mower 100 has been deployed. For example, robotic lawn mower 100 can determine that it has been deployed at location 400 and identify location 400. Robotic lawn mower 100 can determine that is has been deployed at location 400 and identify location 400 based on data generated by sensors 106 and/or data received from user device 210, positioning devices 220, or controller 230 via communications interfaces 118. Robotic lawn mower 100 can use GPS data, RTK data, and/or other types of data to determine it has been deployed at location 400, for example. Via a user interface presented on user device 210, the user can confirm that robotic lawn mower 100 has identified the correct location, in some implementations.

At block 1320, robotic lawn mower 100 receives information about a surrounding environment at the first location. Robotic lawn mower 100 can receive information about the surrounding environment based on data generated by sensors 106, historical data associated with the location, and/or based on information supplied by the user via the user interface presented on user device 210. For some locations, robotic lawn mower 100 may have access to historical data associated with the location that it can rely upon. However, for new locations, historical data for the location may not be accessible by robotic lawn mower 100. For example, robotic lawn mower 100 can retrieve historical data associated with location 400 and identify the presence of obstacles such as tree 410 and wellhead 412, as well as identify boundary 432. Robotic lawn mower 100 can also teach itself about the surrounding environment by navigating through lawn 430, for example, and detecting the presence of obstacles such as tree 410 and wellhead 412 based on data generated by sensors 106. Robotic lawn mower 100 can also receive information about major obstacles such as home 406 and driveway 408 from the user.

At block 1330, robotic lawn mower 100 receives a user input from a user via a user device. For example, the user can provide a user input via the user interface presented on user device 210, and that user input can be transmitted to and received by robotic lawn mower 100. The user input can include a boundary, such as boundary 432 at location 400. The user can indicate boundary 432 via the user interface in variety of ways, such as by drawing the boundary on a map of location 400 or providing coordinates associated with the boundary. The user input can also include a mow pattern for lawn 430, such as any of mow patterns 1210 discussed above. For example, user device 210 may display a plurality of potential mow patterns available for selection, and then receive a user selection of one of the displayed mow patterns. The desired mow pattern can be based on a preference of an owner of home 406 that is known by the user. The user input can also include a planned path for robotic mower 100 to follow when mowing lawn 430. The user can indicate the planned path in a variety of ways, such as by drawing the planned path on a map of location 400 or selecting a previously followed path from a previous time when robotic lawn mower 100 mowed lawn 430. In some implementations, based on boundary 432 and the locations of known obstacles at location 400, the user interface can present different options for planned paths to the user that are automatically generated. The user can then select between the different options of the automatically generated planned paths.

At block 1340, robotic lawn mower 100 operates based on the user input to mow a lawn at the first location. For example, robotic lawn mower 100 can mow lawn 430 based on the user input received at block 1330. Robotic lawn mower can mow lawn 430 while staying within boundary 432 and following a planned path provided by the user. Robotic lawn mower 100 can also mow lawn 430 in accordance with a mow pattern selected by the user. The user input received at block 1330 can be stored in memory 104 and used by processing circuitry 102 to affect operation of robotic lawn mower 100, for example by sending control signals to traction motor system 114 and blade motor system 116. While robotic lawn mower 100 is mowing lawn 430, it can continuously monitor its location based on location data output by one or more of sensors 106, for example, as described above with respect to the GPS, GPS-RTK, and beacon-based systems.

At block 1350, robotic lawn mower 100 detects an obstacle in the lawn at the first location based on sensor data. For example, while navigating through lawn 430, robotic lawn mower 100 can use data generated by sensors 106 to detect that it is near any one of playset 402, patio 404, home 406, driveway 408 tree 410, wellhead 412, retaining wall 414, culvert 420, or mailbox 422 at location 400. Robotic lawn mower 100 can detect the presence of any of these obstacles based on data such as ultrasound/radar data as generated by system 810, based on one or more LIDAR scans such as LIDAR scan 910, based on one or more camera images such as camera image 1010. Robotic lawn mower 100 can also use presence sensors, proximity sensors, and other types of sensors and combinations thereof to detect the obstacle in lawn 430.

At block 1360, robotic lawn mower 100 operates to avoid the obstacle and continue mowing the lawn at the first location. For example, after robotic lawn mower 100 detects that it is near and heading towards any one of playset 402, patio 404, home 406, driveway 408 tree 410, wellhead 412, retaining wall 414, culvert 420, or mailbox 422 at location 400, it can navigate to avoid any of these obstacles. Processing circuity 102, after determining that robotic lawn mower 100 is indeed near and heading towards an obstacle, can provide one or more control signals to traction motor system 114 to steer robotic lawn more 100 away from the obstacle such that robotic lawn mower 100 avoids a potential collision with the obstacle. As a result, any potential damage to either robotic lawn mower 100 or the obstacle can be avoided, and robotic lawn mower 100 can continue mowing lawn 430 in accordance with the user input received at block 1330.

At block 1370, robotic lawn mower 100 identifies a second location where robotic lawn mower 100 has been deployed. For example, robotic lawn mower 100 can determine that it has been moved to a second residential location separate from location 400 and identify the second residential location. Robotic lawn mower 100 can also determine that it has been moved to a commercial location separate form location 400 and identify the commercial location. Robotic lawn mower 100 can determine that is has been deployed at the second location and identify the second location based on data generated by sensors 106 and/or data received from user device 210, positioning devices 220, or controller 230 via communications interfaces 118. Robotic lawn mower 100 can use GPS data, RTK data, and/or other types of data to determine it has been deployed at the second location, for example. In some examples, robotic lawn mower 100 may then repeat blocks 1320-1360, except with respect to the second location rather than the first location (e.g., receiving information about a surrounding environment at the second location, receiving user input with respect to the second location, operating the robotic lawn mower based on the user input to mow a lawn at the second location, detecting an obstacle at the second location operating the robotic lawn mower to avoid the obstacle and continue mowing). In some examples, blocks 1310-1360 may be repeated at each new location that a user brings robotic lawn mower 100 for mowing. Unlike robotic lawn mowers that are simply stationed in one place, robotic lawn mower 100 can serve as an assistant to the mobile professional and travel with the mobile professional to different locations to perform different services.

Although the blocks of process 1300 are described as being implemented by robotic lawn mower 100, at least in some examples, these blocks may be implemented more specifically by processing circuitry 102.

Although the blocks of process 1300 are illustrated in a particular order, in some embodiments, one or more of the blocks can be executed partially or entirely in parallel, can be executed in a different order than illustrated in FIG. 13, or can be bypassed. For example, robotic lawn mower 100 may receive information about a surrounding environment at the first location in block 1320 while robotic lawn mower 100 is performing one or more of blocks 1340, 1350, and 1360 (e.g., during the course of mowing the lawn at the first location). As another example, in some implementations or instances, blocks 1310 and 1370 are not performed by robotic lawn mower 100 when executing process 1300. As another example, in some implementations or instances, blocks 1350 and 1360 are not performed by robotic lawn mower 100 when executing process 1300.

In some examples, subsequent to an initial or previous mowing at a location (e.g., the first location) in which robotic lawn mower 100 receives user input (e.g., indicating a boundary 432, mowing pattern, and/or planned path), robotic lawn mower 100 (or processing circuitry 102) executes the process 1300 or a portion thereof. For example, on a subsequent day or week after the initial or previous mowing, robotic lawn mower 100 may be deployed again at the first location (block 1310), and proceed to execute blocks 1320 1360 or 1320 through 1370 of FIG. 13. In some examples, in block 1340, the robotic lawn mower 100 may mow the lawn at the first location according to a pre-planned path, which may be based the mowing performed at the initial or previous mowing or may be based on new user input (e.g., at block 1330) indicating a (new) pre-planned path.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising”, or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled”are not restricted to physical or mechanical connections or couplings.

As used herein, unless otherwise limited or defined, discussion of particular directions is provided by example only, with regard to particular embodiments or relevant illustrations. For example, discussion of “top”, “front”, or “back” features is generally intended as a description only of the orientation of such features relative to a reference frame of a particular example or illustration. Correspondingly, for example, a “top” feature can sometimes be disposed below a “bottom” feature (and so on), in some arrangements or aspects. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first”, “second”, etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A robotic lawn mower, comprising:
a traction motor system;
a blade motor system;
sensors configured to generate data associated with operation of the robotic lawn mower;
wheels driven by the traction motor system for moving and turning the robotic lawn mower;
a blade driven by the blade motor system for cutting grass; and
processing circuitry configured to:
receive a user input from a user device, the user input received from a user via a user interface presented on the user device, the user input indicating a boundary and a mow pattern for a location for use by the robotic lawn mower;
operate the wheels and the blade of the robotic lawn mower, via control of the traction motor system and the blade motor system, in accordance with the user input such that the robotic lawn mower mows a lawn at the location based on the boundary and the mow pattern;
detect an obstacle in the lawn based on the data generated by the sensors; and
operate, via control of the traction motor system, the wheels of the robotic lawn mower such that the robotic lawn mower avoids the obstacle in the lawn and continues to mow the lawn based on the boundary and the mow pattern.

2. The robotic lawn mower of claim 1, further comprising a handle that moves between a first position and a second position, wherein the user guides the robotic lawn mower using the handle when the handle is in the first position, and wherein the robotic lawn mower operates without guidance from the user at the handle when the handle is in the second position.

3. The robotic lawn mower of claim 1, wherein the processing circuitry comprises:
a microcontroller for receiving the data from the sensors and operating the wheels and the blade of the robotic lawn mower; and
a computing device for receiving the data from the sensors from the microcontroller, generating commands used to operate the wheels and the blade of the robotic lawn mower based on the data from the sensors, and providing the commands to the microcontroller.

4. The robotic lawn mower of claim 1, wherein the processing circuitry is configured to save a map of the lawn at the location in a memory and use the map of the lawn at the location to mow the lawn at the location.

5. The robotic lawn mower of claim 1, wherein the processing circuity is further configured to determine the location of the robotic lawn mower by communicating with a beacon.

6. The robotic lawn mower of claim 5, wherein the beacon is installed in a vehicle or a trailer for transporting the robotic lawn mower, or wherein the beacon is placed within the lawn by the user.

7. The robotic lawn mower of claim 1, wherein the processing circuitry is further configured to determine the location of the robotic lawn mower by communicating with one or more satellites.

8. The robotic lawn mower of claim 1 wherein, subsequent to operating the wheels and the blade of the robotic lawn mower such that the robotic lawn mower mows the lawn at the location based on the boundary and the mow pattern, the processing circuitry is further configured to:
identify the location as a first location where the robotic lawn mower has been deployed;
receive information about a surrounding environment at the first location; and
control the robotic lawn mower to mow the lawn again at the first location based on user input indicating a first planned path for the robotic lawn mower to follow to mow the lawn at the first location.

9. The robotic lawn mower of claim 8, wherein the processing circuitry is further configured to:
identify a second location where the robotic lawn mower has been deployed;
receive information about a surrounding environment at the second location;
control the robotic lawn mower to mow a lawn at the second location based on a second user input received from the user via the user interface, the second user input indicating a second planned path for the robotic lawn mower to follow to mow the lawn at the second location.

10. The robotic lawn mower of claim 8, wherein the information about the surrounding environment at the first location comprises the boundary.

11. A method, comprising:
receiving, by processing circuitry of a robotic lawn mower, a user input from a user device, the user input received from a user via a user interface presented on the user device, the user input indicating a boundary and a mow pattern for a location for use by the robotic lawn mower;
operating, by the processing circuitry, wheels and a blade of the robotic lawn mower, via control of a traction motor system and a blade motor system, in accordance with the user input such that the robotic lawn mower mows a lawn at the location based on the boundary and the mow pattern;
detecting, by the processing circuitry, an obstacle in the lawn based on data generated by sensors coupled to the processing circuitry; and
operating, by the processing circuitry, via control of the traction motor system, the wheels of the robotic lawn mower such that the robotic lawn mower avoids the obstacle in the lawn and continues to mow the lawn based on the boundary and the mow pattern.

12. The method of claim 11, wherein the robotic lawn mower further comprises a handle that moves between a first position and a second position, the method further comprising:
operating, by the robotic lawn mower, in a manual mode wherein the user guides the robotic lawn mower using the handle when the handle is in the first position, and
operating, by the robotic lawn mower, without guidance from the user at the handle when the handle is in the second position.

13. The method of claim 11, further comprising:
receiving, by a microcontroller of the processing circuitry, the data from the sensors;
operating, by the microcontroller, the wheels and the blade of the robotic lawn mower; and
receiving, by a computing device of the processing circuitry, the data from the sensors from the microcontroller,
generating, by the computing device, commands used to operate the wheels and the blade of the robotic lawn mower based on the data from the sensors;
providing, by a computing device, the commands to the microcontroller.

14. The method of claim 11, further comprising:
saving, by the processing circuitry, a map of the lawn at the location in a memory;
using, by the processing circuitry, the map of the lawn at the location to mow the lawn at the location.

15. The method of claim 11, further comprising:
determining, by the processing circuitry, the location of the robotic lawn mower by communicating with a beacon.

16. The method of claim 15, wherein the beacon is installed in a vehicle or a trailer for transporting the robotic lawn mower, or wherein the beacon is placed within the lawn by the user.

17. The method of claim 11, further comprising:
determining, by the processing circuitry, the location of the robotic lawn mower by communicating with one or more satellites.

18. The method of claim 11, wherein, subsequent to operating the wheels and the blade of the robotic lawn mower such that the robotic lawn mower mows the lawn at the location based on the boundary and the mow pattern, the method further comprises:
identifying, by the processing circuitry, the location as a first location where the robotic lawn mower has been deployed;
receiving, by the processing circuitry, information about a surrounding environment at the first location; and
controlling, by the processing circuitry, the robotic lawn mower to mow the lawn again at the first location based on user input indicating a first planned path for the robotic lawn mower to follow to mow the lawn at the second location.

19. The method of claim 18, further comprising:
identifying, by the processing circuitry, a second location where the robotic lawn mower has been deployed;
receiving, by the processing circuitry, information about a surrounding environment at the second location;
controlling, by the processing circuitry, the robotic lawn mower to mow a lawn at the second location based on a second user input received from the user via the user interface, the second user input indicating a second planned path for the robotic lawn mower to follow to mow the lawn at the second location.

20. The method of claim 18, wherein receiving the information about the surrounding environment at the first location comprises receiving the boundary.

21-34. (canceled)
